(19) United States
(12) Patent Application Publication
(10) Pub. No.: US 2009/0133801 A1
(43) Pub. Date: May 28, 2009

(54) SUBSTRATE ATTACHING APPARATUS

(76) Inventor: Seok Hee SHIM, Seongnam-si (KR)

Correspondence Address: KED & ASSOCIATES, LLP, P.O. Box 221200, Chantilly, VA, 20153-1200, US

(21) Appl. No.: 12/255,099

(22) Filed: Oct. 21, 2008

(30) Foreign Application Priority Data
Nov. 23, 2007 (KR) 10-2007-0120426
Nov. 23, 2007 (KR) 10-2007-0120427

(51) Int. Cl. B32B 38/00; B32B 41/00; B32B 37/00

(52) U.S. Cl. 156/64; 156/350; 156/285

(57) ABSTRACT

A substrate attaching apparatus and method are provided. The substrate attaching apparatus may include an upper chamber, a lower chamber, an upper chuck, a lower chuck, a position controller, and a discharging device. The lower chamber may adjoin the upper chamber to define an attaching space therewith. The upper chuck may be provided at a lower portion of the upper chamber so as to mount a first substrate thereon. The lower chuck may be recessed into an upper surface of the lower chamber and/or may be integrally formed with the lower chamber so as to mount a second substrate thereon. The position controller may be provided above the upper chamber to control a position of the first substrate. The discharging device may be provided above the upper chamber or below the lower chamber to apply vacuum pressure to the attaching space.

### CROSS-REFERENCE TO RELATED PATENT APPLICATION

This application claims the benefit of Korean Patent Application Nos. 10-2007-0120426 & No. 10-2007-0120427, filed in Korea on Nov. 23, 2007, the entirety of which is incorporated herein by reference.

### BACKGROUND

1. Field

A substrate attaching apparatus is provided, and more particularly, a substrate attaching apparatus for the manufacture of flat display panels is provided.

2. Background

The development of information technology has brought forth an increase in the need for a wide variety of display devices. Thus, many types of flat panel devices, such as, for example, liquid crystal displays (LCD), plasma display panels (PDP), and electro luminescent displays (ELD), have recently been developed, and some of these flat panel devices are already being widely used.

Of these flat panel devices, LCDs have superior resolution, lighter weight, slimness, and lower power consumption characteristics over older cathode ray tube (CRT) technology, and may be used in portable image display device applications. For example, a thin film transistor (TFT)-LCD panel has an array substrate with a plurality of TFTs arranged in a matrix, and a color filter substrate having a color filter, a light shielding layer, and the like formed thereon. The panel is manufactured by attaching the array substrate and the color filter substrate, injecting liquid crystal into the gap before, during or after the attachment, and then sealing the gap. The process of attaching the substrates is an important factor in determining the quality of an LCD panel.

### BRIEF DESCRIPTION OF THE DRAWINGS

The embodiments will be described in detail with reference to the following drawings in which like reference numerals refer to like elements wherein:

FIG. 1 is a sectional view of a substrate attaching apparatus in accordance with an embodiment as broadly described herein;

FIG. 2 is a flowchart of a substrate attaching method in accordance with an embodiment as broadly described herein;

FIGS. 3 through 6 are sectional views illustrating operation of a substrate attaching apparatus in accordance with an embodiment as broadly described herein; and

FIG. 7 is a sectional view of a substrate attaching apparatus in accordance with another embodiment as broadly described herein.

### DETAILED DESCRIPTION

A substrate attaching system and method as embodied and broadly described herein will now be described more fully with reference to the accompanying drawings, in which exemplary embodiments are shown. In the description below, like reference elements have been assigned like reference numbers in different embodiments.

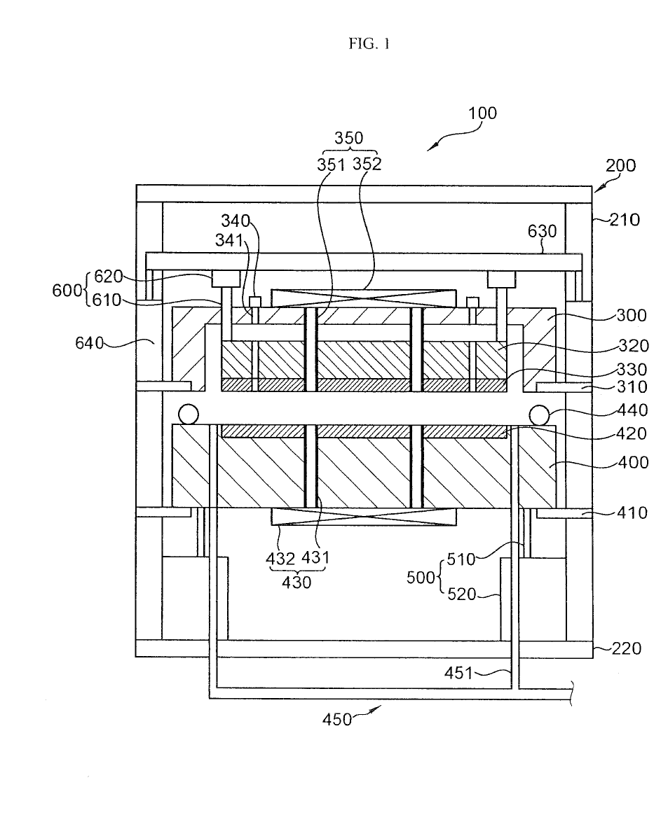

Referring to FIG. 1, a substrate attaching apparatus 100 may include a frame 200, an upper chamber 300, a lower chamber 400, a driver 500, and a position controller 600.

The frame 200 may at least partially define an external shape of the substrate attaching apparatus 100, and may support the respective components thereof The frame 200 may include a plurality of columns 210 provided beneath the frame 200 and fixed at the perimeter of a base 220 to which the driver 500 is fixed. Beams (not shown) and braces (not shown) may also be provided between the columns 210 to reinforce the columns 210.

A first supporting bar 310 may be installed at an appropriate portion of each column 210 so as to be connected to the side portion of the upper chamber 300 and support the upper chamber 300 relative to the column 210. A second supporting bar 410 may be installed at an appropriate portion of each column 210 to support the lower chamber 400.

The upper chamber 300 may be fixed to the upper portion of the frame 200, and the undersurface of the upper chamber 300 may face the lower chamber 400 to define an attaching space therebetween. An upper table 320 may be provided within the upper chamber 300, and a position controller 600 (to be described below) may be provided at an upper edge of the upper table 320. An upper chuck 330 may be provided on the undersurface of the upper table 320, and a first substrate (P1) may be mounted to the undersurface of the upper chuck 330. The upper chuck 330 may be, for example, an electrostatic chuck (ESC) that uses electrostatic power to hold the first substrate (P1). In certain embodiments, the upper table 320 may be integrally formed with the upper chuck 330, so that the upper table 320 provides for mounting of the first substrate (P1). A substrate separating device 350 that suctions or presses the first substrate (P1) to hold the first substrate (P1) on or separate the first substrate (P1) from the upper chuck 330 may be provided with the upper chamber 300.

A camera part 340 that views the respective positions of the first substrate (P1) and a second substrate (P2) positioned in the lower chamber 400 may be provided, for example, on the upper surface of the upper chamber 300, or other location as appropriate. The camera part 340 may determine an alignment of the first substrate (P1) held by the upper chuck 330 of the upper table 320 relative to the second substrate (P2) (to be described below). The camera part 340 may make this determination in a number of different ways, including using through-holes 341 formed in the upper chamber 300 and the upper table 320 to observe a superimposition of align marks (not shown) provided on the first substrate (P1) and the second substrate (P2). Alternatively, the camera part 340 may be positioned so as to observe superimposition of at least two edges or corners of the first substrate (P1) and the second substrate (P2) that are diagonal to each other. The first substrate (P1) may be the color filter substrate of an LCD panel, and the second substrate (P2) may be the array substrate of an LCD panel, or vice versa.

The substrate separating device 350 may include a plurality of separating pins 351 that pass through the upper chamber 300 and the upper table 330, and a separating pin driver 352 provided outside of the upper chamber 300 to move the separating pins 351 vertically, i.e., raise or lower the separating pins 351 as necessary.

The separating pins 351 may be formed as hollow tubes, so that the first substrate (P1) may be suctioned by a vacuum generated within the separating pins 351 and held in place by a mounting force imparted by the upper chuck 330. After the first substrate (P1) is mounted on the upper chuck 330, the separating pins 351 may block vacuum pressure to allow the first substrate (P1) to separate from the upper chuck 330 and the first substrate (P1) to descend naturally toward the second substrate (P2).

The lower chamber 400 is disposed below the upper chamber 300, and may be elevated toward and positioned against the upper chamber 300 to form an attaching space. A lower chuck 420 may be provided on the upper surface of the lower chamber 400. In certain embodiments, the lower chuck 420 may be positioned in a recess formed in the upper surface of the lower chamber 400, or may be integrally formed with the lower chamber 400.

The lower chuck 420 may be moved by a substrate moving device 430 (to be described below). The lower chuck 420 receives and holds the second substrate (P2) thereon. Because the lower chuck 420 may be inserted in and combined with the upper surface of the lower chamber 400 and/or integrally formed with the lower chamber 400 as described above, the volume within the chambers 300 and 400 may be reduced, so that the time taken to discharge atmospheric pressure and form a vacuum in the attaching space may also be reduced. More particularly, this allows the position controller 600 (to be described below) to be installed above the upper chamber 300 instead of the lower chamber 400, with the lower chuck 420 inserted in and combined with the upper surface of the lower chamber 400 and/or integrally formed with the lower chamber 400. Also, by reducing the inner volume of the chambers 300 and 400, the number of vacuum pumps needed to discharge atmospheric pressure to generate a vacuum in the attaching space may be reduced, and thus, power consumption may also be reduced. Further, by integrally forming the lower chuck 420 with the lower chamber 400, equipment manufacturing cost may be reduced. The lower chuck 420 may also be an electrostatic chuck (ESC) that holds the second substrate (P2) in place using electrostatic power.

A sealing member 440 may be provided on the perimeter of the lower chamber 400. The sealing member 440 may provide a seal between the upper and lower chambers 300 and 400 when they are positioned to form the attaching space.

A substrate movement device 430 may be provided below the lower chamber 400 to mount the second substrate (P2) to the lower chuck 420 or to separate the second substrate (P2) from the lower chuck 420. The substrate movement device 430 may include a plurality of pins 431 that pass through the lower chamber 400 and the lower chuck 420, and a pin driver 432 provided outside the lower chamber 400 to move the plurality of pins 431 vertically, i.e. ascend and descend within the through holes.

The pins 431 may take the form of hollow tubes. When the second substrate (P2) is inserted into the space between the chambers 300 and 400, the pins 431 may support the second substrate (P2). In addition, after the first substrate (P1) and the second substrate (P2) are attached to each other, the pins 431 may elevate the attached substrates (P1+P2), and the attached substrates (P1+P2) may be unloaded from the lower chamber 400.

A lower discharging device 450 may be provided below the lower chamber 400. The lower discharging device 450 may be configured to form a vacuum pressure in the attaching space formed by the upper chamber 300 and the lower chamber 400. The lower discharging device 450 may include an external vacuum pump (not shown), and a discharging tube 451 that provides for communication between the vacuum pump and the attaching space.

The lower discharging tube 451 may be configured to have the vacuum pump connected thereto so as to generate a vacuum pressure in the attaching space and may simultaneously supply N2 processing gas for use during an attaching process while vacuum pressure is being generated. The lower discharging tube 451 may also supply pressurizing gas to obtain atmospheric pressure in the attaching space. The vacuum pump may be a dry pump, a turbo molecular pump (TMP), a mechanical booster pump, or other pump as appropriate.

The driver 500 may be provided at the lower portion of the frame 200, and may raise and lower the lower chamber 400 relative to the upper chamber 300 to form an attaching space between the lower chamber 400 and the upper chamber 300. The driver 500 may be installed at each edge of the base 220 of the frame 200, and may include columns 510 that support the lower chamber 400, and moving members 520 that raise and lower the columns 510.

The moving members 520 may be, for example, hydraulic cylinders (not shown) that generate force for directly raising or lowering the lower chamber 400, or may be provided as an assembly of a motor (not shown), a deceleration device (not shown) that redirects and simultaneously reduces a motive force generated by the motor, a screw-coupled member (not shown) that transfers a rotating movement of the deceleration device to a linear movement, or other device as appropriate. The configurations of the moving members 520 may be obtained through a wide variety of embodiments, and are not limited to the above configurations.

The position controller 600 may be provided above the upper chamber 300 to control a position of the first substrate (P1). The position controller 600 may be, for example, an XY θ coordinate system, or XY θ alignment table, sometimes referred to as a UVW table, that is capable of moving the first substrate (P1) horizontally.

The position controller 600 may include driveshaft 610 that passes through the upper chamber 300 and moves the first substrate (P1) horizontally, and a driveshaft driver 620 that is attached to the top of the driveshaft 610 to relay a driving force to the driveshaft 610. The driveshaft 610 may pass through the upper chamber 300 and be attached to an upper edge of the upper table 320 so as to move the upper table 320 horizontally together with the first substrate (P1).

The upper surface of the driveshaft driver 620 may be attached to a plate 630 (to be described below), and the lower surface thereof may be attached to the driveshaft 610. The driveshaft driver 620 transmits driving force to the driveshaft 610 so as to horizontally move the first substrate (P1). Accordingly, the upper table 320 attached to the driveshaft 610 and the upper chuck 330 attached to the upper table 320 may be moved horizontally, so that the first substrate (P1) mounted on the upper chuck 330 is moved horizontally with respect to the second substrate (P2).

A linear actuator 640 may be provided at an upper portion of each column 210, and may be attached to an upper surface of the first supporting bar 310. The upper surface of the linear actuator 640 may contact the plate 630 (described below) so as to support the plate 630. The linear actuator 640 raise and lower the plate 630, so that the position controller 600 attached to the plate 630 raised or lowered accordingly, and a gap between the first substrate (P1) and the second substrate (P2) is adjusted a corresponding amount.

The linear actuators 640 may be attached to lower surface edge regions of the plate 630, so that the plate 630 is supported by the linear actuators 640. Also, the position controller 600 may be attached to the lower surface of the plate 630, so that when the linear actuator 640 is raised or lowered, the position controller 600 is also raised or lowered. Thus, the upper table 320 attached to the position controller 600 is raised or lowered to adjust the gap between the first substrate (P1) and the second substrate (P2).

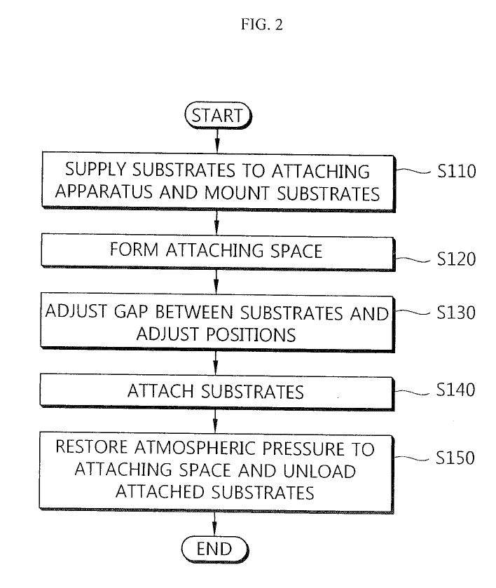

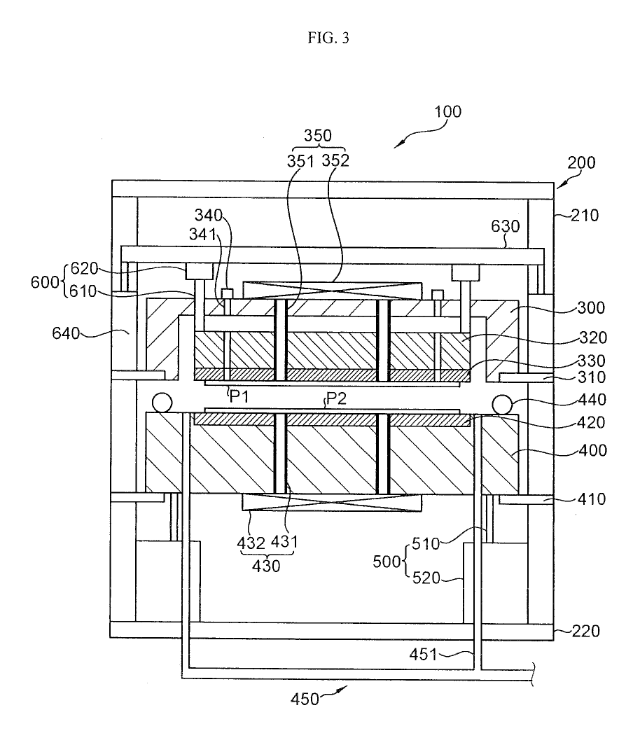

FIG. 2 is a flowchart of a substrate attaching method in accordance with an embodiment as broadly described herein, and FIGS. 3 through 6 illustrate the operation of a substrate attaching apparatus using this method.

Referring to FIGS. 2 through 6, initially, a first substrate (P1) and a second substrate (P2) are supplied to a space between the upper chamber 300 and the lower chamber 400 by a substrate supplying device (not shown).

More particularly, when the first substrate (P1) is first supplied, the first substrate (P1) is inserted between the upper chamber 300 and the lower chamber 400, and is held by the upper chuck 330 of the upper table 320 disposed in the upper chamber 300.

When the second substrate (P2) is supplied, the pins 431 disposed in the lower chamber 400 are elevated to an upper portion of the lower chamber 400 by the pin driver 432, and the second substrate (P2) disposed between the upper chamber 300 and the lower chamber 400 is supported by the pins 431. When the pins 431 are lowered by the pin driver 432, the second substrate (P2) is also lowered, and the second substrate (P2) is mounted on the lower chuck 420 by the mounting force imparted by the lower chuck 420 in operation S110 (refer to FIG. 3).

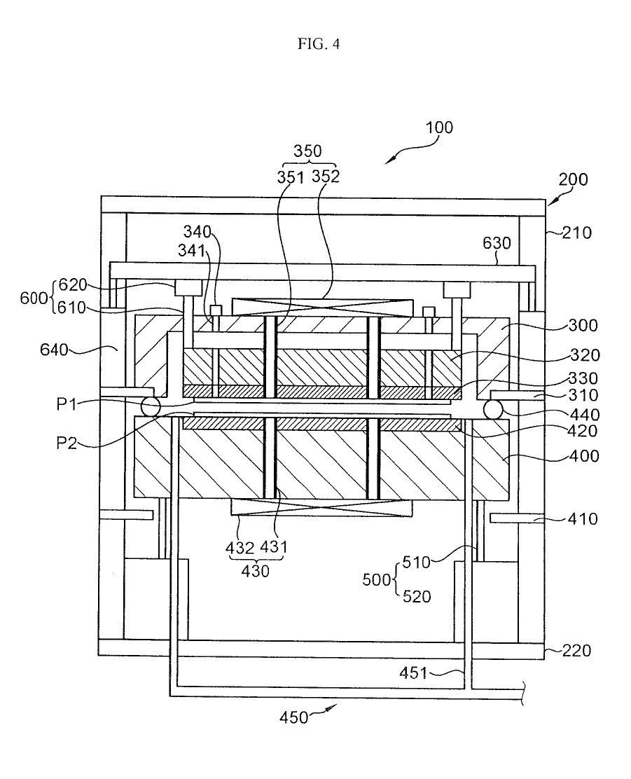

When the mounting of the first substrate (P1) and the second substrate (P2) on the respective chucks 330 and 420 is completed, the driver 500 elevates the lower chamber 400 toward the upper chamber 300, and the upper surface of the lower chamber 400 and the lower surface of the upper chamber 300 are pressed toward one another to form an attaching space in operation S120 (refer to FIG. 4).

The lower chamber 400 is supported by the plurality of drivers 500 that may be capable of independent operation. The moving members 520 disposed on the drivers 500 may operate independently, and the columns 510 may be raised (or lowered) by a corresponding moving member 520 to position the lower chamber 400 proximate the upper chamber 300 and form the attaching space. A seal between the upper chamber 300 and the lower chamber 400 may be maintained by the sealing member 440 provided on the upper peripheral surface of the lower chamber 400.

When the attaching space is formed, the gap between the first substrate (P1) and the second substrate (P2) is adjusted by the linear actuator 640, and the position controller 600 adjusts (aligns) the position of the first substrate (P1) relative to the second substrate in operation S130.

The upper surface of the linear actuator 640 contacts the plate 630 to support the plate 630. The linear actuator 640 raises or lowers the plate 630 so that the position controller 600 attached to the plate 630 is also raised or lowered. Accordingly, the linear actuator 640 raises or lowers the upper table 320 attached to the position controller 600, to adjust the gap between the first substrate (P1) and the second substrate (P2).

The camera part 340 captures the alignment marks (not shown) of the first substrate (P1) and the second substrate (P2) to check an alignment of the first substrate (P1) and the second substrate (P2). Also, the position controller 600 adjusts the position of the upper table 320 to adjust (align) the position of the first substrate (P1) with the second substrate (P2). That is, the position controller 600 moves the upper table 320 and the upper chuck 330 horizontally together with the first substrate (P1).

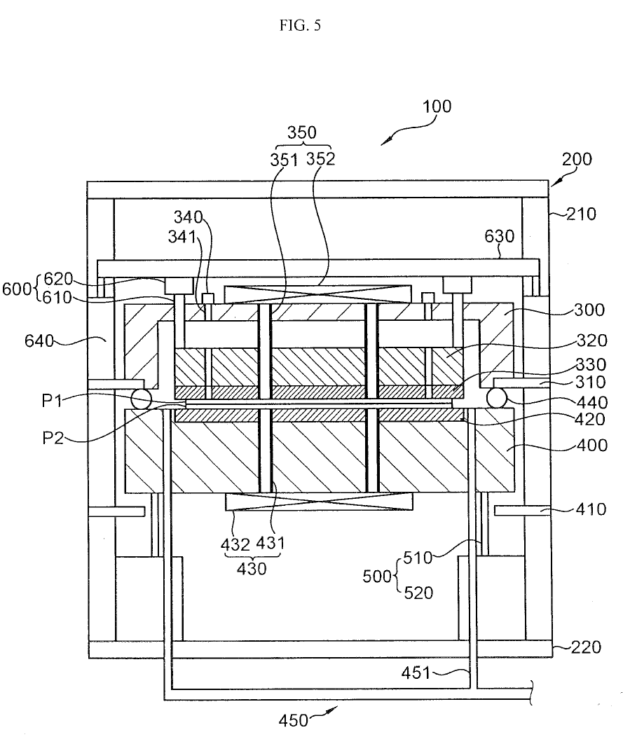

When gap adjustment and position adjustment are completed, vacuum pressure is applied to the attaching space, and the first substrate (P1) mounted to the upper chuck 330 is lowered naturally to the upper surface of the second substrate (P2) to pre-attach the first substrate (P1) and the second substrate (P2). Then, N₂ processing gas is supplied to the outside of the pre-attached first substrate (P1) and second substrate (P2) to apply pressure and firmly attach the first substrate (P1) and the second substrate (P2) in operation S140 (refer to FIG. 5). That is, by increasing the pressure of the attaching space, the difference in internal and external pressures of the pre-attached first substrate (P1) and second substrate (P2) attaches the first substrate (P1) and the second substrate (P2).

In certain embodiments, a sealant is provided on one or both of the substrates P1 and P2 before they are transferred into the processing space and before the substrates P1 and P2 are attached, and then liquid crystal material is injected into a gap between the substrates P1 and P2 after they are attached and sealed. In alternative embodiments, liquid crystal material may be injected into a gap between the substrates P1 and P2, in advance, together with a sealant, and then the substrates P1 and P2 are attached and sealed.

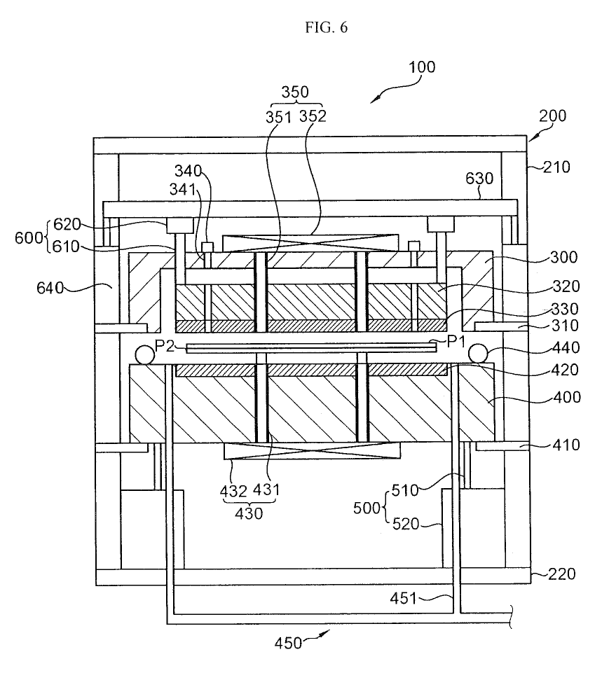

When attaching of the first substrate (P1) and second substrate (P2) is completed, the pressure of the attaching space is restored to atmospheric pressure, and the attached substrates (P1+P2) are unloaded from the substrate attaching apparatus 100 in operation S150 (refer to FIG. 6). In this instance, restoring the pressure to atmospheric pressure allows pressure to be easily controlled, the subsequent withdrawing process may be performed under atmospheric pressure conditions, and further processing is not required.

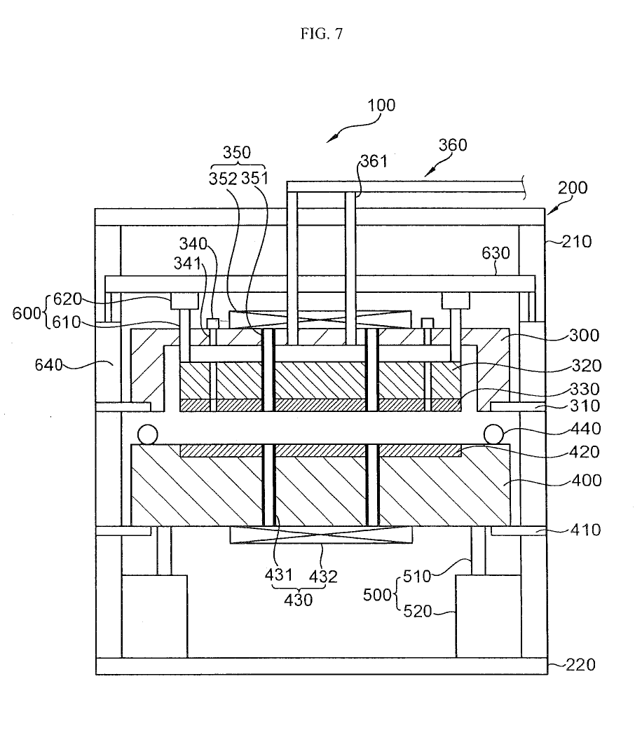

FIG. 7 is a schematic view of a substrate attaching apparatus in accordance with another embodiment as broadly described herein. In the description provided with reference to FIG. 7, description of elements that are similar to those in the above-described embodiments will not be repeated. As illustrated in FIG. 7, a discharging device may be provided as an upper discharging device 360 connected to the upper chamber 300.

The upper discharging device 360 may be installed above the upper chamber 300 to develop vacuum pressure in the attaching space that is formed between the upper chamber 300 and the lower chamber 400. The upper discharging device 360 may include an external vacuum pump (not shown), and an upper discharging tube 361 that provides for communication between the vacuum pump and the attaching space.

The upper discharging tube 361 may be connected the vacuum pump for generating vacuum pressure in the attaching space and may simultaneously supply N2 processing gas during an attaching process while vacuum pressure is being generated, or may supply pressurizing gas for generating pressure to obtain atmospheric pressure in the attaching space. The vacuum pump may be a dry pump, a turbomolecular pump (TMP), a mechanical booster pump, or other type of pump as appropriate.

A substrate attaching system and method as broadly described herein may minimize the inner spaces of the upper chamber and the lower chamber to reduce the time taken to discharge atmospheric pressure and generate a vacuum during the attaching of substrates. By minimizing the inner volumes of the upper chamber and the lower chamber, the number of vacuum pumps needed for discharging atmospheric pressure to generate a vacuum may be minimized. Accordingly, the amount of power consumed to perform processing may also be reduced.

A substrate attaching apparatus is provided that reduces the time taken to discharge atmospheric pressure to generate a vacuum inside an upper chamber and lower chamber during the attachment of substrates.

A substrate attaching apparatus as embodied and broadly described herein may include an upper chamber; a lower chamber adjoining the upper chamber to define an attaching space therewith; an upper chuck disposed below the upper chamber to mount a first substrate thereon; a lower chuck combined into an upper surface of the lower chamber to be integrally formed with the lower chamber, the lower chuck mounting a second substrate thereon; a position controlling unit disposed above the upper chamber to control a position of the first substrate; and a discharging unit installed above the upper chamber to apply vacuum pressure to the attaching space.

Any reference in this specification to “one embodiment,” “an embodiment,” “example embodiment,” “certain embodiment,” “alternative embodiment,” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A substrate attaching apparatus, comprising:
a first chamber;
a second chamber that adjoins the first chamber so as to define an attaching space therebetween;
a first chuck provided with the first chamber so as to receive and hold a first substrate thereon;
a second chuck provided with the second chamber so as to receive and hold a second substrate thereon, wherein a receiving surface of the second chuck is coplanar with an exposed surface of the second chamber on which the second chuck is provided; and
a position controller provided outside of the first chamber so as to control a position of the first substrate relative to the second substrate.

2. The apparatus of claim 1, wherein the first and second chambers are vertically aligned, and the first chamber is positioned above the second chamber, with the attaching space formed therebetween.

3. The apparatus of claim 2, wherein the second chuck is provided in a recess formed in an upper surface of the second chamber that faces the first chamber.

4. The apparatus of claim 2, wherein the second chuck is formed integrally with an upper surface of the second chamber that faces the first chamber.

5. The apparatus of claim 2, wherein the position controller is provided above the first chamber.

6. The apparatus of claim 2, wherein the position controller is a UVW table that moves the first substrate horizontally.

7. The apparatus of claim 6, wherein the UVW table comprises:
a driveshaft that passes through the first chamber; and
a driveshaft driver coupled to an upper portion of the driveshaft so as to transmit a driving force to the driveshaft, wherein the driveshaft moves the first substrate horizontally in response to a driving force received from the driveshaft driver.

8. The apparatus of claim 2, further comprising a discharging device that applies a vacuum pressure to the discharging space formed between the first and second chambers, wherein the discharging device comprises:
an external vacuum pump; and
a discharging tube that extends between the vacuum pump and the attaching space so as to apply the vacuum pressure to the attaching space.

9. The apparatus of claim 8, wherein the discharging device in provided either above the first chamber or below the second chamber.

10. The apparatus of claim 1, wherein the second chuck comprises an electrostatic chuck that uses electrostatic power to hold the second substrate thereon.

11. The apparatus of claim 2, further comprising an inspection device provided with the first chamber, the inspection device comprising:
an image device provided at an upper outside portion of the first chamber; and
at least one inspection hole formed in the first chamber, wherein the image device observes a position of the first substrate relative to the second substrate based on an image thereof observed through the at least one inspection hole.

12. The apparatus of claim 11, wherein the inspection device determines a position of the first substrate relative to the second substrate based on a relative position of alignment marks provided on the first and second substrates, or on an alignment of opposite corners of the first and second substrates.

13. The apparatus of claim 2, further comprising a substrate separating device provided with the first chamber, the substrate separating device comprising:
a plurality of pins that extend through an outer wall of the first chamber, through a table provided with the first chamber that has a receiving surface on which the first chuck is positioned, and through the first chuck; and
a separating pin driver that selectively applies a mounting force to the first substrate through the plurality of separating pins so as to hold or release the first substrate against the first chuck.

14. The apparatus of claim 13, wherein the plurality of pins comprises a plurality of hollow tubes, and wherein the separating pin driver applies a vacuum force to the first substrate through the plurality of hollow tubes to hold the first substrate against the first chuck, and blocks the vacuum force so as to release the first substrate from the first chuck and lower the first substrate onto the second substrate held on the second chuck.

15. The apparatus of claim 2, further comprising a substrate moving device provided with the second chamber, wherein the substrate moving device comprises:
a plurality of pins that extend through the second chamber and the second chuck; and
a driver that selectively raises and lowers the plurality of pins such that the plurality of pins are extended out through the second chuck so as to raise the second substrate positioned thereon, or such that the plurality of pins are retracted into the second chamber so as to position the second substrate on the second chuck.

16. The apparatus of claim 2, further comprising a plurality of driving devices coupled to the second chamber so as to selectively raise the second chamber towards the first chamber to form the attaching space, and lower the second chamber away from the first chamber, wherein each of the plurality of driving devices comprises:
a plurality of columns coupled to the second chamber; and
a corresponding plurality of drivers that selectively raise and lower the plurality of columns so as to selectively raise and lower the second chamber.

17. A method of attaching substrates of a flat panel display, the method comprising:
providing a first substrate and a second substrate to an attaching space formed between a first chamber and a second chamber;
mounting the first substrate on a first chuck provided on the first chamber;
mounting the second substrate on a second chuck such that a receiving surface of the second chuck on which the second substrate is mounted is coplanar with an exposed surface of the second chamber, wherein the first and second substrates face each other in the attaching space when the first and second substrates are mounted on the first and second chucks, respectively;
driving a chamber moving device and moving the second chamber toward the first chamber so as to position the second chamber adjacent to the first chamber and seal the attaching space formed therebetween;
applying a vacuum pressure to the sealed attaching space, and releasing the first substrate from the first chuck so as to pre-attach the first substrate to the second substrate;
supplying a processing gas to the sealed attaching space so as to fully attach the first substrate to the second substrate; and
restoring the attaching space to atmospheric pressure and unloading the attached first and second substrates from the attaching space.

18. The method of claim 17, further comprising adjusting a gap between the first substrate and the second substrate such that the first substrate is positioned on the second substrate after positioning the second chamber adjacent to the first chamber.

19. The method of claim 18, further comprising inspecting a position of the first substrate and the second substrate and adjusting a position of the first and second substrates based on the inspection after adjusting the gap and before applying the vacuum pressure.

20. The method of claim 19, wherein inspecting a position of the first substrate and the second substrate comprises:
capturing an image of alignment marks provided on the first and second substrates through inspection holes formed in the first chamber and the first chuck, or capturing an image of an alignment of opposite corners of the first and second substrates through the inspection holes; and
moving the first substrate so as to align the first substrate relative to the second substrate.

21. The method of claim 17, wherein unloading the attached first and second substrates from the attaching space comprises driving a substrate moving device to separate a lower surface of the second substrate from the second chuck, and raising the second substrate with the first substrate attached thereto away from the second chuck.
